(19) United States
(12) Patent Application Publication
(10) Pub. No.: US 2026/0228873 A1
(43) Pub. Date: Aug. 6, 2026

(54) MAINTENANCE METHOD AND MAINTENANCE SYSTEM FOR A LASER OPTICS SYSTEM

(71) Applicant: TRUMPF Werkzeugmaschinen SE + Co. KG, Ditzingen (DE)

(72) Inventors: Karsten Scholz, Leonberg (DE); Björn Luong, Warmbronn (DE)

(21) Appl. No.: 19/575,967

(22) Filed: Mar. 24, 2026

Related U.S. Application Data
(63) Continuation of application No. PCT/EP2024/074692, filed on Sep. 4, 2024.

(30) Foreign Application Priority Data
Sep. 26, 2023 (DE) 10 2023 126 059.6

(51) Int. Cl. G06T 7/00; G06T 7/60; G06T 7/73

(52) U.S. Cl. CPC G06T 7/0002; G06T 7/60; G06T 7/73; G06T 2207/20081; G06T 2207/30168

(57) ABSTRACT

A maintenance method for detecting soilings on a laser optics system of a laser beam system, the method including producing a speckle image with a multiplicity of speckles on a speckle image blank, wherein the speckle image is formed by irradiating a light-sensitive surface of the speckle image blank with a laser beam passing through the laser optics system. The method includes evaluating the speckle image, by determining at least one speckle geometry of at least one of the multiplicity of speckles and comparing the at least one determined speckle geometry with at least one stored characteristic speckle geometry. A soiling of the laser optics system is detected when a predetermined similarity or agreement of the determined speckle geometry with the at least one stored characteristic speckle geometry is found. The method includes outputting soiling information. The soiling information includes at least a number of detected soilings.

### CROSS REFERENCE TO RELATED APPLICATIONS

This application is a continuation of International Application No. PCT/EP2024/074692 (WO 2025/067833A1), filed on Sep. 4, 2024, and claims benefit to German Patent Application No. DE 10 2023 126 059.6, filed on Sep. 26, 2023. The aforementioned applications are hereby incorporated by reference herein.

### FIELD

The invention relates to a maintenance method and a maintenance system for detecting soilings on a laser optics system of a laser beam system.

### BACKGROUND

Laser beam systems with laser optics systems for generating a laser beam are known from the prior art and are used, for example, for workpiece processing in manufacturing. The laser optics system comprises a plurality of optical components which are used to form the beam profile of the laser beam. To enable highly precise processing by the laser beam and to avoid power losses of the laser beam, high cleanliness requirements are placed on the laser optics system.

However, the laser beam system, in particular when processing workpieces, is typically exposed to air pollution in the form of airborne particles. The suspended particles reach the laser optics system via air circulation and lead to soilings of the optical components. This leads to unwanted impairments of the laser beam guidance within the laser optics system, resulting in a loss of laser power and the formation of scattered light. This can lead to a reduction in the quality of workpiece processing and to material rejects.

To prevent the consequences of impairment of the laser optics system, these are usually checked for soilings. A method known from the prior art involves producing so-called speckle images, wherein the laser beam is briefly directed onto a light-sensitive surface. This process involves a so-called burning off of the light-sensitive surface, wherein the burn-off residues produce a speckle-like pattern depending on the locally distributed laser radiation.

The resulting speckle images must then be painstakingly interpreted by experts in order to obtain an indication of possible quality-reducing soilings in the laser optics system of the laser beam system. Furthermore, ordinary speckle images has a multiplicity of speckles, making interpretation by an expert time-consuming and prone to errors. This means that soiling can only be detected with a time delay and, moreover, with a high degree of uncertainty, thus perpetuating the disadvantages mentioned above.

From DE 10 2018 214 170 A1, a machine-learning device for a quality assessment of a laser beam intensity distribution is known, wherein an acrylic block is irradiated by a laser beam to produce a burning pattern of the beam profile. However, the described device is not suitable for detecting individual soilings in the laser optics system.

### SUMMARY

In an embodiment, the present disclosure provides a maintenance method for detecting soilings on a laser optics system of a laser beam system, the method comprising producing a speckle image with a multiplicity of speckles on a speckle image blank, wherein the speckle image is formed by irradiating a light-sensitive surface of the speckle image blank with a laser beam passing through the laser optics system. The method further comprises evaluating the speckle image, by determining at least one speckle geometry of at least one of the multiplicity of speckles and comparing the at least one determined speckle geometry with at least one stored characteristic speckle geometry. A soiling of the laser optics system is detected when a predetermined similarity or agreement of the determined speckle geometry with the at least one stored characteristic speckle geometry is found. The method further comprises outputting soiling information. The soiling information includes at least a number of detected soilings.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic view of a maintenance method for detecting soilings on a laser optics system of a laser beam system;

FIG. 2 shows a schematic view of a laser beam system with a laser optics system and a maintenance system for detecting soilings on the laser optics system of the laser beam system; and

FIG. 3 shows a speckle image in a partially photographic and a partially schematic view.

### DETAILED DESCRIPTION

In an embodiment, the present disclosure provides a method and a device for reliably and quickly detecting soilings on a laser optics system.

According to an embodiment of the present disclosure, a maintenance method is provided.

The maintenance method is designed to detect soiling on a laser optics system of a laser beam system. The maintenance method is designed in particular for detecting individual soilings on a laser optics system.

The maintenance method is particularly suitable for use on a laser processing machine for processing workpieces. Preferably, the laser beam system includes a solid-state laser. The laser beam system is particularly preferably designed to produce a laser beam with a wavelength between 1050 nanometers and 1100 nanometers, in particular a wavelength of 1064 nanometers or 1080 nanometers. In accordance with the present disclosure, it has been found that the maintenance method described above and below is particularly suitable for laser beam systems with the aforementioned specifications.

According to the present disclosure, a soiling can be understood as a locally limited adhesion of one or a plurality of suspended particles, in particular particles, to, in particular, an optical component of the laser optics system, which typically causes a local impairment of the laser radiation of the laser beam and can cause thermal damage. For example, in the case of metallic particles, local melting of the laser optics system can occur, causing the particle to be burned into the laser optics system.

The maintenance method has at least the following method steps:

A first method step a) of the maintenance method provides for the production of a speckle image. The speckle image is typically created by irradiating a light-sensitive surface of a speckle image blank with the laser beam of the laser beam system. In this process, the laser beam passes through the laser optics system before hitting the light-sensitive surface, allowing soilings that impair the laser beam to be imaged on the light-sensitive surface. In addition to a multiplicity of speckles characteristic of the burn-off process of the light-sensitive surface, characteristic speckles are created which can be attributed to the impairment of the laser beam by the soiling of the laser optics system.

The light-sensitive surface of the speckle image blank, in particular the entire speckle image blank, is preferably designed as photographic paper. This allows for a particularly high resolution during the production of the speckle image, thereby increasing the procedural accuracy of the maintenance method.

The production of the speckle image preferably takes place under predetermined parameters of the laser beam system. Alternatively, it can be provided that the parameters are read out from a machine control system of the laser beam system during exposure of the light-sensitive surface. In other words, the parameters of the laser beam system are known during the production of the speckle image. In particular, the laser power and/or the distance of the laser optics system to the light-sensitive surface is known during production. This allows for a particularly precise evaluation of the speckle image.

A further method step b) of the maintenance method involves evaluating the speckle image. The evaluation comprises determining at least one speckle geometry of at least one of the speckles produced during exposure of the light-sensitive surface. Typically, the speckle geometries are determined by a plurality of, in particular all, speckles in the speckle image. In other words, the speckle geometry is determined both by the speckles characteristic of the burn-off process of the light-sensitive surface and by the characteristic speckles. Evaluating the speckle image can be understood as isolating the speckles within the speckle image.

Graphical image evaluation algorithms are preferably used to evaluate the speckle image. In other words, the evaluation is preferably carried out using computers. This allows the evaluation and therefore the maintenance method to be carried out more quickly. The speckle geometries are typically stored in a data storage device for further processing.

A further method step c) of the maintenance method involves comparing at least one determined speckle geometry with at least one stored characteristic speckle geometry. In other words, the previously determined speckle geometry is compared with reference geometries, wherein the reference geometries of which were demonstrably produced by a soiling of the laser optics system. If the comparison reveals that the determined speckle geometry exhibits a predetermined similarity or agreement with the characteristic speckle geometry, a soiling that accounts for the determined speckle geometry is detected.

Preferably, the speckle geometry is compared with a plurality of, in particular a multiplicity of, stored characteristic speckle geometries. Each characteristic speckle geometry is to be understood as a possible speckle formation caused by soiling of the laser optics system. As the number of stored characteristic speckle geometries increases, the probability of detecting soilings in the maintenance method can be increased.

Computer-aided comparison algorithms are preferably used to compare the speckle geometry with the characteristic speckle geometry. This allows the comparison and therefore the maintenance method to be carried out even faster. The detected soilings are typically stored in a data storage device for further processing.

A further method step g) of the maintenance method provides for the output of a soiling information. The soiling information is designed to provide information about possible soiling of the laser optics system. The soiling information includes at least the number of soilings identified by comparing the speckle geometries with the characteristic speckle geometries.

Preferably, the evaluation of the speckle image, the comparison of the speckle geometry with the characteristic speckle geometry and/or the output of the soiling information is performed automatically. In other words, the maintenance method can be carried out substantially automatically, resulting in a faster process flow and a higher degree of automation.

In summary, the present disclosure provides a maintenance method in which a speckle image is produced with a laser optics system to be tested, forming characteristic speckles, wherein the characteristic speckles are due to a laser beam impaired by soilings. The speckle image is then analyzed with regard to the characteristic speckles and an underlying soiling is detected. The maintenance method according to the present disclosure thus represents a fast and reliable method for the early detection of soiling of the laser optics system, thereby overcoming the disadvantages of the prior art. The maintenance method according to the present disclosure allows for targeted maintenance, in particular cleaning of the laser optics system and/or replacement of optical components of the laser optics system.

In an embodiment of the maintenance method, in method step b) a speckle position is determined for the at least one speckle. In other words, in addition to the speckle geometry, the position of the speckle is also determined. Typically, in method step g), the speckle position is output as a projected soiling position by the soiling information. The projected soiling position is to be understood as a position within the beam cross-section. In other words, the location of the soiling in a cross-sectional plane of the laser beam perpendicular to a laser beam propagation direction can be determined. This allows maintenance to be carried out in a more targeted manner.

An embodiment of the maintenance method includes an additional method step d), which provides for the determination of a degree of soiling. In other words, the degree of impairment of the laser optics system or the laser beam itself by the detected soilings is determined. The degree of soiling can be detected depending on the number of determined soilings. Alternatively or additionally, the degree of soiling can be determined depending on the at least one projected soiling position. Typically, the determined degree of soiling is output in method step g). The degree of soiling can, for example, cause a planned maintenance method to be carried out earlier or later than planned. This increases the flexibility of maintenance.

Furthermore, a further development of the maintenance method is preferred in which the degree of soiling increases with decreasing distance of the projected soiling position from a speckle image center and/or with increasing number of detected soilings.

In an embodiment, the maintenance method includes method step e), which provides for the detection of a contaminated optical component of the laser optics system containing the soiling. In other words, the position of the soiling can be determined along the laser beam propagation direction. The contaminated component can be determined by determining the contour sharpness of the speckle geometry caused by the soiling. By determining the contour sharpness, a soiling distance between the light-sensitive surface and the soiling can be determined. With knowledge of the constructive design of the laser optics system, the soiling distance can thus be attributed to a determined optical component. Typically, the detected contaminated component is output in method step g). This allows the maintenance of the laser optics system to be limited to a single optical component, making maintenance even faster.

An optical component can include, but is not limited to, an optical lens, in particular a focusing lens, a protective glass, a flat plate and/or a mirror.

In an embodiment of the maintenance method, it is provided that the method step c) is carried out by a self-learning algorithm. By using a self-learning algorithm, the maintenance method can be performed even faster, taking into account a multiplicity of speckles, speckle geometries, and characteristic speckle geometries. This further increases the probability of detecting soilings.

The self-learning algorithm is preferably trained using a multiplicity of speckle geometries and/or characteristic speckle geometries whose relationships with soiling of the laser optics system are known. To detect a relationship between a speckle geometry and/or characteristic speckle geometry and a soiling, for example, a manual assignment of the speckle geometry to one or to no soiling can be carried out by one or a plurality of experts. For example, a manual evaluation of speckle images can be provided, which are “labeled” accordingly for the purpose of training the self-learning algorithm. Preferably, the speckle images are evaluated by an expert after maintenance has been performed or during maintenance on the laser beam system and are automatically sent back to the maintenance system. The evaluated speckle images can also be provided to the maintenance system manually by an operator or automatically via a mobile terminal. Preferably, a multiplicity of evaluated speckle images are transmitted via known data transmission to a central data storage device of the maintenance system, which serves as the basis for training the self-learning algorithm.

The advantages of the present disclosure are also achieved by a maintenance system.

The maintenance system is designed for maintaining a laser optics system of a laser beam system described above and below. The maintenance method is typically designed to detect soilings on the laser optics system.

In particular, the maintenance system is designed to carry out the maintenance method described above and below.

The maintenance system has at least one input unit with an imaging device. The input unit is designed for inputting a speckle image. Preferably, the imaging device is designed for digital input of the speckle image into the maintenance system. Digital input significantly simplifies the further processing of the speckle image.

Preferably, the imaging device is designed as a camera, in particular as a digital camera.

The maintenance system also comprises an evaluation unit. The evaluation unit is designed to determine at least one speckle geometry from the speckle image. Preferably, the evaluation unit is designed to perform computer-aided image evaluation algorithms.

Furthermore, the evaluation unit is designed to determine soiling by comparing the speckle geometry with at least one stored characteristic speckle geometry. Preferably, the evaluation unit is designed to perform computer-aided comparison algorithms.

The maintenance system also comprises at least one output unit. The output unit is designed for producing and outputting soiling information. The output unit can be designed for graphical output of the soiling information, in particular to be shown on a display.

The maintenance system can be designed as a maintenance computer, the maintenance computer comprising the input unit, the evaluation unit, and/or the output unit.

In an embodiment, the maintenance system comprises a mobile terminal. The mobile terminal can have an input unit and/or an output unit. This enables the transmission of the speckle image to the evaluation unit, especially over long geographical distances. This allows the speckle image to be input particularly quickly and easily on-site at the laser beam system.

In an preferred embodiment, the maintenance system comprises a mobile terminal. The mobile terminal can include the output unit. This enables the transmission of soiling information, especially over long distances. This allows maintenance of the laser beam system to be carried out at a distance from the evaluation unit.

Further advantages of the present disclosure are also evident from the description and the drawings. Similarly, the features mentioned above and the features still to be explained can each be used on their own or together in any desired combinations according to the present disclosure. The embodiments shown and described should not be understood as an exhaustive list, but rather are of an exemplary character.

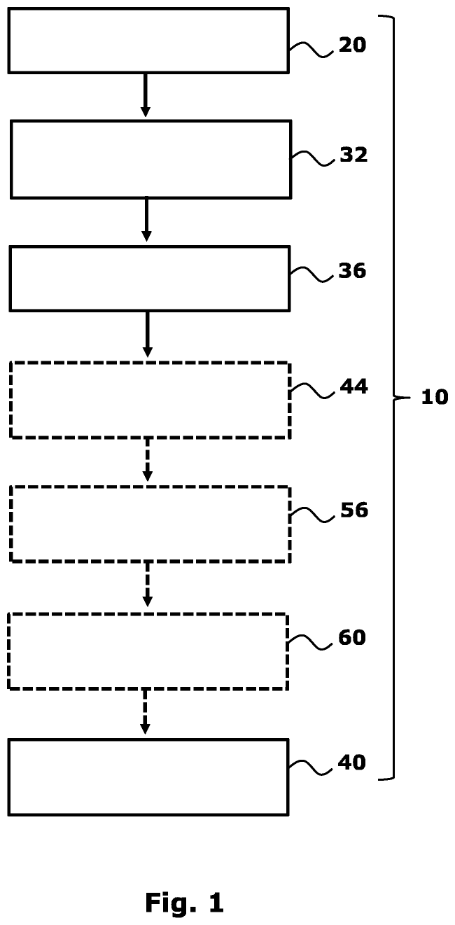

FIG. 1 shows a schematic view of a maintenance method 10 according to the present disclosure. The maintenance method 10 is explained below with reference to the other figures in the drawing.

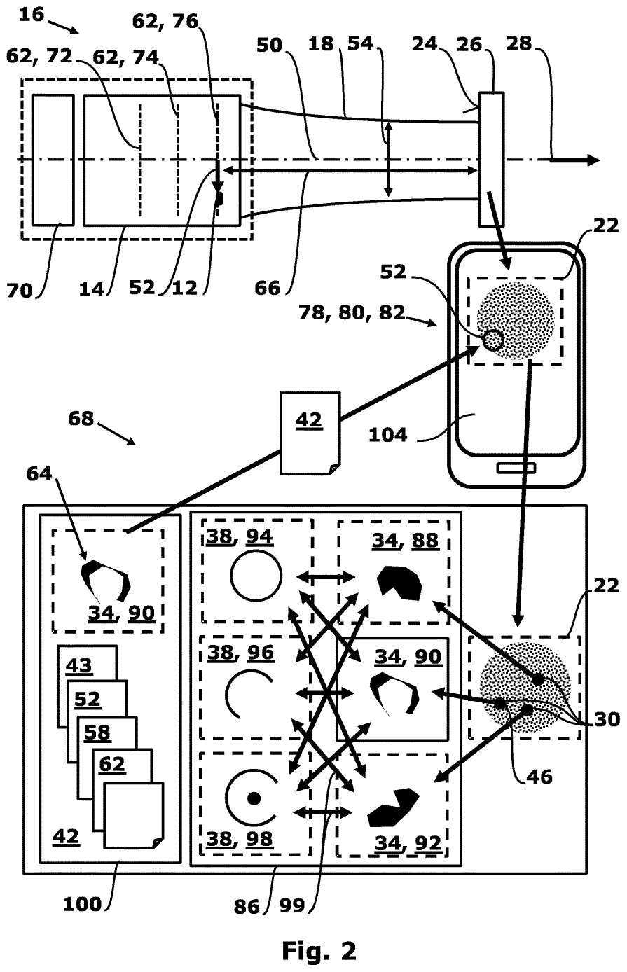

The maintenance method 10 is used to detect soilings 12 (see FIG. 2) on a laser optics system 14 (see FIG. 2) of a laser beam system 16 (see FIG. 2). The soiling 12 typically impairs the beam path of a laser beam 18 (see FIG. 2) of the laser beam system 16, which reduces the processing quality of the laser beam system 16.

The maintenance method 10 has at least the following method steps:

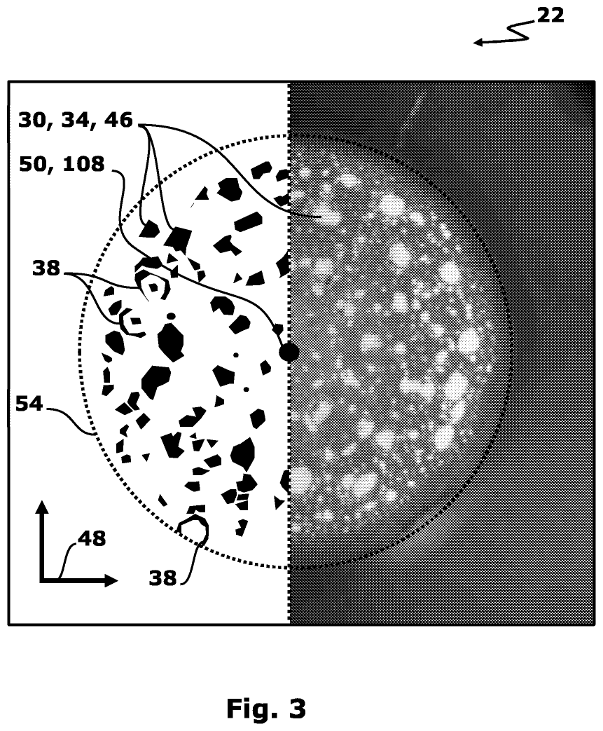

A first method step 20 provides for the production of a speckle image 22 (see FIGS. 2, 3). The speckle image 22 is typically produced by irradiating a light-sensitive surface 24 (see FIG. 2) of a speckle image blank 26 (see FIG. 2). In other words, the laser beam 18, which passes through the laser optics system 14 in the laser beam propagation direction 28 (see FIG. 2), is directed onto the speckle image blank 26.

The light-sensitive surface 24, in particular the entire speckle image blank 26, is preferably designed as photographic paper. This ensures a high-quality speckle image 22 is produced.

Exposing the light-sensitive surface 24 to the laser beam 18, in particular for a short time, typically causes a controlled reaction, in particular so-called burn-off, of the light-sensitive surface 24. In other words, the laser beam 18 vaporizes the light-sensitive surface 24. This process creates burn-off residue on the speckle image blank 26, which, depending on the locally acting light intensity of the laser beam 18, forms high-contrast speckles 30 (see FIGS. 2, 3). The speckle image 22 typically exhibits a multiplicity of speckles 30.

A further method step 32 provides for the evaluation of the speckle image 22. The evaluation includes determining at least one speckle geometry 34 (see FIG. 2) of at least one of the speckles 30. Preferably, the speckle geometry 34 is determined by a plurality of, in particular all, speckles 30, thereby increasing the accuracy of the maintenance method 10.

When determining the speckle geometry 34, preferably contiguous regions with the same contrast and/or with the same brightness are combined to form a geometric shape. In other words, the speckle image 22 is broken down into its speckles 30. Determining the speckle geometry 34 can be done using graphical image evaluation algorithms. This can increase the method speed and the method accuracy.

A subsequent method step 36 involves comparing at least one determined speckle geometry 34 with at least one stored characteristic speckle geometry 38 (see FIG. 2). Preferably, the determined speckle geometry 34 is compared with a plurality of, in particular a multiplicity of, stored characteristic speckle geometries 38. This makes it possible to find or detect various soilings 12. A soiling 12 on the laser optics system 14 is typically detected when the determined speckle geometry 34 has a predetermined similarity and/or agreement with the characteristic speckle geometry 38.

A further method step 40 involves outputting soiling information 42 (see FIG. 2). The soiling information 42 comprises at least a number 43 (see FIG. 2) of the detected soilings 12.

In a special version of the maintenance method 10, a method step 44 is provided, in which a speckle position 46 (see FIGS. 2, 3) of the at least one speckle 30 is determined. The speckle position 46 is typically determined in the speckle image 22. Preferably, the speckle position 46 is determined in a coordinate system 48 (see FIG. 3) of the speckle image 22. This allows a particularly quick and easy connection to be established with a laser beam axis 50 (see FIGS. 2, 3), enabling the contamination 12 to be detected more quickly on the laser optics system 14. Typically, the speckle position 46 is output as a projected soiling position 52 (see FIG. 2) by the soiling information 42. In other words, the soiling position 52 indicates the location of the soiling in a beam cross-section 54 (see FIGS. 2, 3) of the laser beam 18. This further simplifies the detection of the soiling 12 on the laser optics system 14.

In a further special version of the maintenance method 10, an additional method step 56 is provided, in which a determination of degree of soiling 58 (see FIG. 2) is made depending on the at least one projected soiling position 52 and/or the number 43 of determined soilings 12.

For example, it can be provided that a single detected soiling 12, a small-area speckle geometry 34 caused by the soiling 12 and/or a large distance of the soiling position 52 to the laser beam axis 50 leads to a low degree of soiling 58. In other words, the impairment of the laser beam 18 by the soiling 12 can be considered minor in this case. This can mean that maintenance of the laser optics system 14 can be postponed, for example.

Furthermore, it can be provided, for example, that a plurality of detected soilings 12, a large-area speckle geometry 34 caused by at least one soiling 12 and/or a small distance of the soiling position 52 to the laser beam axis 50 leads to a high degree of soiling 58. In other words, the impairment of the laser beam 18 by the soiling 12 can be considered significant in this case. This can mean that maintenance of the laser optics system 14 can be postponed, for example, in this case.

Typically, soiling information 42 indicates a determined degree of soiling 58. In other words, the degree of soiling 58 can be output together with the number 43 of soilings 12.

In an embodiment of maintenance method 10, an additional method step 60 is provided, in which a contaminated optical component 62 (see FIG. 2) of the laser optics system 14 exhibiting the soiling 12 is determined. The contaminated component 62 is typically determined by determining a contour sharpness 64 (see FIG. 2) of the speckle geometry 34 caused by the soiling. With knowledge of the contour sharpness 64, a soiling distance 66 (see FIG. 2) between the soiling 12 and the light-sensitive surface 24 can be detected, and the soiling 12 can be assigned to an optical component 62 located at the soiling distance 66. This allows the detection of the soiling 12 on the laser optics system 12 to be limited to the contaminated optical component 62, thus enabling faster maintenance.

Preferably, the contaminated optical component 62 and/or the soiling distance 66 are identified and output in the soiling information 42 according to method step 40.

The method step 36 is particularly preferably carried out by a self-learning algorithm. When comparing the speckle geometry 34 with a characteristic speckle geometry 38, the maintenance method 10 can be carried out particularly quickly and efficiently by including a multiplicity of speckles 30 and characteristic speckle geometries 38. This can increase the probability of detecting soilings 12 in the maintenance method 10.

FIG. 2 shows an embodiment of a maintenance system 68.

The maintenance system 68 is configured and trained for maintaining the laser optics system 14 of the laser beam system 16. The maintenance system 68 is designed to perform the maintenance method 10 (see FIG. 1).

The laser beam system 16 is typically a laser processing machine for processing a workpiece. Preferably, the laser beam system 16 has a laser beam generator 70 for producing the laser beam 18. The laser beam generator 70 is typically a solid-state laser. The laser beam 18 preferably has a wavelength between 1050 nanometers and 1100 nanometers, particularly preferably a wavelength of 1064 nanometers or 1080 nanometers.

The laser beam 18 produced in the laser beam generator 70 is configured within the laser optics system 14 as it propagates in the laser beam propagation direction 28 in order to enable optimal processing of the workpiece. In other words, the laser optics system 14 can be used to set important method parameters of the laser beam 18, for example a focus position and/or a beam cross-section 54.

The laser optics system 14 typically has a plurality of optical components 62. The optical components 62 can be designed, for example, as an optical lens, in particular as a focusing lens, as protective glass, as a flat plate and/or mirror. As shown, the laser optics system 14 has three optical lenses 72, 74, 76. The optical lenses 72, 74, 74 are arranged one behind the other in the laser beam propagation direction 28.

As shown, the optical lens 76 has a soiling 12. The soiling 12 can impair the laser beam 18 and thus reduce the processing quality of the laser beam system 16.

To ensure the processing quality of the laser beam system 16, the maintenance method 10 can be carried out using the exemplary maintenance system 68 shown. As shown, a speckle image blank 26 can be positioned in the beam path of the laser beam 18 to cause the light-sensitive surface 24 to be exposed by the laser beam 18. The speckle image 22 is produced in response to the exposure. The produced speckle image 22 is then further processed by the maintenance system 68.

The maintenance system 68 comprises at least one input unit 78, wherein the input unit is designed for inputting a speckle image 22. The input unit 78 is preferably designed for digital reading, in particular scanning and/or graphic imaging, of the speckle image 22. Typically, the input unit 78 comprises an imaging device 80 for this purpose, in particular a camera.

As shown, the input unit 78 is integrally formed in or on a mobile terminal 82. This makes it particularly easy to input the speckle image 22. Typically, the light-sensitive surface 24 of the speckle image blank 26 is digitally imaged by the imaging device 80. This allows the further processing of the speckle image 22 to be carried out more quickly.

The speckle image 22 can, as shown, be transmitted from the mobile terminal 82 to a spatially distant maintenance computer 84. The maintenance computer 84 typically has a higher computing power than the mobile terminal 82, so that the further processing of the speckle image 22 can be carried out faster when transferred to the maintenance computer 84.

The maintenance system 68 also has an evaluation unit 86. As shown, the evaluation unit 86 is integrally formed on the maintenance computer 84.

The evaluation unit 86 is designed for determining at least one speckle geometry 34 from the speckle image 22. In other words, the evaluation unit 86 combines at least one contiguous region with the same contrast and/or brightness into a geometric shape. Typically, the evaluation unit 86 determines a plurality, in particular all, of the speckle geometries 34 contained in the speckle image 22. In other words, the evaluation unit 86 can be configured to isolate the speckle image 22 into speckle geometries 34. As shown, three exemplary speckle geometries 88, 90, 92 are determined by the evaluation unit 86.

The evaluation unit 86 is also designed to compare at least one speckle geometry 34 with at least one stored characteristic speckle geometry 38. In other words, the evaluation unit 86 comprises at least one characteristic speckle geometry 38. Typically, the evaluation unit 86 comprises a plurality, in particular a multiplicity, of characteristic speckle geometries 38. Each of the characteristic speckle geometries 38 is characteristic of a soiling 12. By individually comparing the characteristic speckle geometry 38 with the determined speckle geometry 34, a conclusion can be drawn about soiling if a predetermined degree of similarity is present. In other words, a soiling 12 can be detected by the formation of the speckle geometry 14. The evaluation unit is therefore designed for detecting soilings 12.

As shown, three exemplary characteristic speckle geometries 94, 96, 98 are stored. As further shown, a single comparison, represented by the arrows 99, is carried out between each characteristic speckle geometry 94, 96, 98 and each detected speckle geometry 88, 90, 92. For reasons of clarity, only two arrows 99 are provided with a reference sign. The detected speckle geometry 90 exhibits a high degree of similarity to the characteristic speckle geometry 96. The evaluation unit 86 therefore detects a soiling 12 as the cause of the formation of the speckle geometry 90.

The maintenance unit 68 also has at least one output unit 100. The output unit 100 is designed for producing and outputting soiling information 42.

The output unit 100 is designed for the indirect and/or direct output of the soiling information 42. For example, the soiling information 42 can be output directly to the maintenance computer 84. Furthermore, it can be provided that the soiling information 42 is transmitted to the mobile terminal 82 and displayed on a display 104 of the mobile terminal 82. In other words, the mobile terminal 82 can be configured as part of the output unit 100.

The soiling information 42 comprises at least the number 43 of identified soilings 12. Preferably, the soiling information 42 also comprises a speckle geometry 90 caused by the soiling 12, a projected soiling position 52, a contaminated optical component 62 and/or a soiling distance 66.

The soiling information 42, in particular the soiling position 52, is preferably displayed graphically on the display 104 of the mobile terminal 82. This allows maintenance to be carried out particularly quickly by a maintenance technician.

FIG. 3 shows a speckle image 22 in a partially photographic view (shown on the right) as well as in a partially schematic view (shown on the left) for further explanation.

As a result of the exposure of the light-sensitive surface 24 (see FIG. 2) of the speckle image blank 26 (see FIG. 2), an inhomogeneous, so-called burn-off of the light-sensitive surface 24 can be effected within the beam cross-section 54. The inhomogeneous burn-off process leads to the formation of speckles 30, which are shown as dark regions in the schematically represented view and as light regions in the photographically represented view.

As shown, the speckle image 22 comprises a multiplicity of speckles 30, which are typically arranged in a ring around the laser beam axis 50, or a speckle image center 108. The speckles 30 exhibit different speckle geometries 34. For the sake of clarity, only three speckles 30 and three speckle geometries 34 are provided with a reference sign.

As shown, the speckle image 22 exhibits three characteristic speckle geometries 38. The characteristic speckle geometries 38 differ in particular from the other speckle geometries 34 of the speckles 30 by their circular or ring-shaped formation. The characteristic speckle geometries 38 are characteristic of a soiling 12 of the laser optics system 14 (see FIG. 2).

The characteristic speckle geometries 38 can be detected by the maintenance method 10 and the maintenance system 68, which can eliminate the soilings 12 underlying the respective characteristic speckle geometry 38.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10 Maintenance method;
12 Soiling;
14 Laser optics system;
16 Laser beam system;
18 Laser beam;
20 Method step;
22 Speckle image;
24 Light-sensitive surface;
26 Speckle image blank;
28 Laser beam propagation direction;
30 Speckle;
32 Method step;
34 Speckle geometry;
36 Method step;
38 Characteristic speckle geometry;
40 Method step;
42 Soiling information;
43 Number;
44 Method step;
46 Speckle position;
48 Coordinate system;
50 Laser beam axis;
52 Projected soiling position;
54 Beam cross-section;
56 Method step;
58 Degree of soiling;
60 Method step;
62 Optical component;
64 Contour sharpness;
66 Soiling distance;
68 Maintenance system;
70 Laser beam generator;
72 Optical lens;
74 Optical lens;
76 Optical lens;
78 Input unit;
80 Imaging device;
82 Mobile terminal;
84 Maintenance computer;
86 Evaluation unit;
88 Exemplary speckle geometry;
90 Exemplary speckle geometry;
92 Exemplary speckle geometry;
94 Exemplary characteristic speckle geometry;
96 Exemplary characteristic speckle geometry;
98 Exemplary characteristic speckle geometry;
99 Arrow;
100 Output unit;
104 Display;
108 Speckle image center.

1. A maintenance method for detecting soilings on a laser optics system of a laser beam system, the method comprising:
a) producing a speckle image with a multiplicity of speckles on a speckle image blank, wherein the speckle image is formed by irradiating a light-sensitive surface of the speckle image blank with a laser beam passing through the laser optics system;
b) evaluating the speckle image, by determining at least one speckle geometry of at least one of the multiplicity of speckles;
c) comparing the at least one determined speckle geometry with at least one stored characteristic speckle geometry, wherein a soiling of the laser optics system is detected when a predetermined similarity or agreement of the determined speckle geometry with the at least one stored characteristic speckle geometry is found;
g) outputting soiling information, wherein the soiling information includes at least a number of detected soilings.

2. The maintenance method according to claim 1, wherein in method step b) a speckle position is determined for the at least one speckle of the multiplicity of speckes; wherein in method step g) the speckle position is output as a projected soiling position in the soiling information.

3. The maintenance method according to claim 2, further comprising:
d) determining a degree of soiling depending on the at least one projected soiling position and/or the number of determined soilings;
wherein the degree of soiling is output in method step g).

4. The maintenance method according to claim 3, wherein the degree of soiling increases with decreasing distance of the at least one projected soiling position from a speckle image center and/or with an increase in the number of the detected soilings.

5. The maintenance method according to claim 1, further comprising:
e) detecting a contaminated optical component of the laser optics system exhibiting one of the detected soilings by determining a contour sharpness of the speckle geometry caused by the respective detected soiling;
wherein the detected contaminated optical component is output in method step g).

6. The maintenance method according to claim 1, wherein the method step c) is performed by a self-learning algorithm.

7. A maintenance system for a laser optics system of a laser beam system for detecting soilings on the laser optics system and for performing the maintenance method according to claim 1, comprising:
at least one input unit with a camera configured to input the speckle image into the maintenance system;
an evaluation unit configured to determine the at least one speckle geometry from the speckle image and to determine a soiling by comparing the at least one speckle geometry with the at least one stored characteristic speckle geometry;
at least one output unit configured to produce and output the soiling information.

8. The maintenance system according to claim 7, further comprising a mobile terminal, wherein the mobile terminal includes the input unit.

9. The maintenance system according to claim 7, further comprising a mobile terminal, wherein the mobile terminal includes the output unit.
